(19) United States
(12) Patent Application Publication
(10) Pub. No.: US 2018/0349814 A1
(43) Pub. Date: Dec. 6, 2018

(54) ADAPTIVE ANALYTICS FRAMEWORK AND METHOD

(71) Applicant: Mu Sigma Business Solutions Pvt. Ltd., Bengaluru (IN)

(72) Inventors: Deepinder DHINGRA, Bangalore (IN); Rajat SRIVASTAV, Bangalore (IN); Vishwajit Yogenkumar VYAS, Bangalore (IN); Naveen PRABHU, Bangalore (IN)

(73) Assignee: Mu Sigma Business Solutions Pvt. Ltd., Bengaluru (IN)

(21) Appl. No.: 15/960,711

(22) Filed: Apr. 24, 2018

(30) Foreign Application Priority Data
Jun. 1, 2017 (IN) 201741019335

(51) Int. Cl. G06Q 10/06; G06N 5/02

(52) U.S. Cl. CPC G06Q 10/0633; G06N 5/022

(57) ABSTRACT

An adaptive analytics framework is provided. The adaptive analytics framework includes one or more customizable analytic blocks with a source code therein. Each analytic block is configured to receive input data associated with at least one business problem and to implement an analytic workflow to determine one or more solutions to the business problem. The framework also includes an integration module configured to facilitate integration of the one or more customizable analytic blocks with an external platform.

### PRIORITY STATEMENT

The present application hereby claims priority under 35 U.S.C. § 119 to Indian patent application number 201741019335 filed 1 Jun. 2017, the entire contents of which are hereby incorporated herein by reference.

### FIELD

Embodiment of the invention relates generally to an adaptive analytics framework for determining solutions to a business problem, and more particularly to a framework and method for identifying customizable analytic blocks based upon a type of the business problem and implementing analytic workflows to determine solutions to the business problem.

### BACKGROUND

One of the key aspects of a modern business enterprise is to address a wide range of business issues or problems in a systematic and efficient manner. Certain business problems are poorly defined and are constantly changing. Most of the existing problem solving techniques use traditional software targeted towards specific business problems. Individual software products may be developed to address each of these business problems. Such software products are robust, scalable and may be standardized to generate solutions to the specific business problems. However, such software may not be not flexible and cannot adapt to changing business contexts and problems. Moreover, these products have tightly coupled design or blocks and cannot be consumed in part. In addition, software development cycles for these products can be too long and such products may not be able to cope with increasing rate of change.

Some organizations utilize customized problem solving techniques for their individual business problems. For example, Open Source and Commercial APIs may address the needs of scale. However, these techniques fail to address the need for customization for specific business problems.

### SUMMARY

The following summary is illustrative only and is not intended to be in any way limiting. In addition to the illustrative aspects, example embodiments, and features described above, further aspects, example embodiments, and features will become apparent by reference to the drawings and the following detailed description.

Example embodiments provide an adaptive analytics framework and method to enable solutions to multiple business problems in varied classes.

Briefly, according to an example embodiment, an adaptive analytics framework is provided. The adaptive analytics framework includes one or more customizable analytic blocks with a source code therein. Each analytic block is configured to receive input data associated with at least one business problem and to implement an analytic workflow to determine one or more solutions to the business problem. The framework also includes an integration module configured to facilitate integration of the one or more customizable analytic blocks with an external platform.

According to yet another example embodiment, adaptive analytics framework is provided. The framework includes a memory having computer-readable instructions stored therein. The framework also includes a processor configured to receive one or more business problems and identify one or more customizable analytic blocks based upon a problem class of the received business problem. Each customizable analytic block is configured to receive input data associated with one or more business problems and to implement an analytic workflow to determine one or more solutions to the business problem. The framework also includes an integration module configured to facilitate integration of the identified one or more customizable analytic blocks with an external platform.

According to yet another example embodiment, adaptive analytics framework is provided. The framework includes a memory having computer-readable instructions stored therein. The framework also includes a processor configured to analyze data associated with analytic workflows of a plurality of business problems of one or more problem classes, identify recurring patterns across the analytic workflows of the business problems in the respective problem class and generate one or more customizable analytic blocks based upon the identified recurring patterns. The customizable analytic blocks are configured to implement an analytic workflow to generate solutions of the business problems in the respective problem class.

According to yet another example embodiment, an adaptive analytics framework is provided. The framework includes a memory having computer-readable instructions stored therein. The framework also includes a processor configured to receive a problem statement corresponding to a business problem and identify at least one attribute contributing to the business problem based upon a situation-control question (SCQ) matrix, a factor map and a hypothesis matrix associated with the business problem. The processor is further configured to generate a comprehensive version of the business problem based on the identified at least one attribute. The processor is further configured to identify one or more customizable analytic blocks based upon a problem class of the comprehensive version of the business problem. Each customizable analytic block is configured to receive input data associated with the business problem and to implement an analytic workflow to determine one or more solutions to the business problem. The framework further includes an integration module which is configured to facilitate integration of the identified one or more customizable analytic blocks with an external platform.

According to yet another example embodiment, adaptive analytics framework is provided. The framework includes a memory having computer-readable instructions stored therein. The framework also includes a processor configured to receive a problem statement corresponding to a business problem and determine one or more connections for the problem statement by comparing the problem statements with multiple business problem statements and to generate a connection score for the problem statement. The processor is further configured to determine a problem class of the business problem based on the generated connection store. The processor is further configured to identify one or more customizable analytic blocks based upon the problem class of the one or more business problems. Each customizable analytic block is configured to receive input data associated with one or more business problems and to implement an analytic workflow to determine one or more solutions to the business problem. The framework further includes an integration module configured to facilitate integration of the identified one or more customizable analytic blocks with an external platform.

According to yet another example embodiment, a method of solving a business problem is provided. The method involves determining a problem class of one or more business problems and selecting one or more customizable analytic blocks based upon the problem class. The method further involves integrating the selected customizable analytic blocks with an external platform and implementing an analytic workflow for the selected customizable analytic blocks to generate solutions of the one or more business problems. The method further involves customizing the one or more analytic blocks based upon type of the business problems.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is an example representation of a business problem network, according to an example embodiment;

FIG. 2 is a block diagram of an adaptive analytics framework, according to an example embodiment;

FIG. 3 is an example representation of customizable analytic blocks for providing solutions to business problems associated with a plurality of problem classes, according to an example embodiment.

FIG. 4 is a flow chart illustrating a process for solving a business problem using the analytics framework of FIG. 2, according to an example embodiment;

FIG. 5 is a flow chart illustrating a process for generating the customizable analytic blocks of FIG. 2, according to an example embodiment;

FIG. 6 is an example layout with phases of analytic workflow implemented to solve a business, according to an example embodiment;

FIG. 7 is a graphical representation of sensitivity and specificity of the results obtained using the customized analytic block and previous techniques, according to an example embodiment;

FIG. 8 shows an example layout with phases of analytic workflow implemented to solve a business problem, according to an example embodiment;

FIG. 9 is a table with comparison of results obtained for a classification business problem using the analytic software and the previous technique, according to an example embodiment;

FIG. 10 is a table with comparison of results obtained for a segmentation business problem using the analytic software and the previous technique, according to an example embodiment; and

FIG. 11 is a block diagram of an embodiment of a computing device for implementing a guided analytic workflow to solve a business problem, according to an example embodiment.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to an adaptive analytics framework and method for identifying one or more customizable analytic blocks to determine one or more solutions for business problems. Example embodiments of the present technique provide an integrated analytics framework that enables solutions to multiple business problems in varied classes.

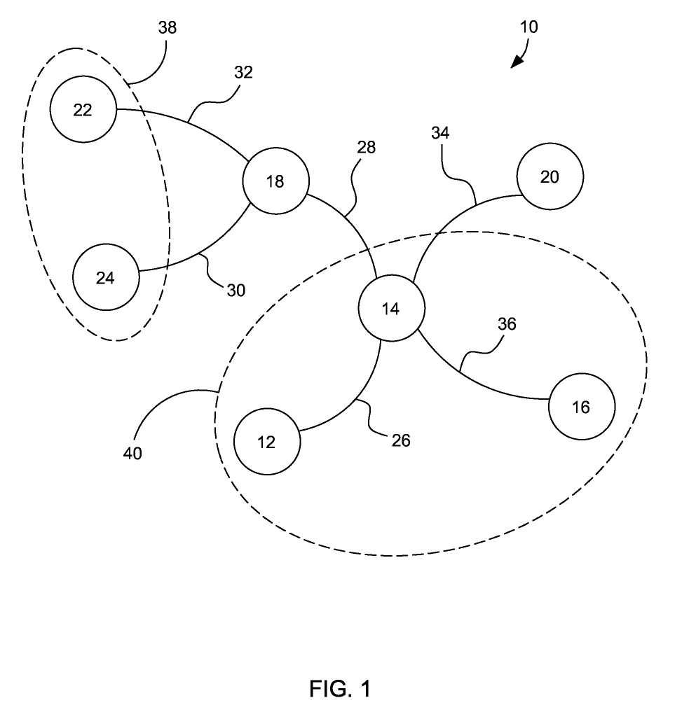

FIG. 1 is an example representation of a business problem network 10, according to an example embodiment. The business problem network 10 includes a plurality of business problems such as represented by reference numerals 12 through 24. The plurality of business problems such as 12 through 24 are associated with business organizations, retail outlets, consumer outlets and so forth. Examples of business problems 12 through 24 include causes of revenue leakage, customer buying patterns, impact of price rise on sales, identifying sales drivers and the like for an establishment such as a retail store. The business problems 12 through 24 are coupled to each other through a number of connections such as represented by reference numerals 26 through 36.

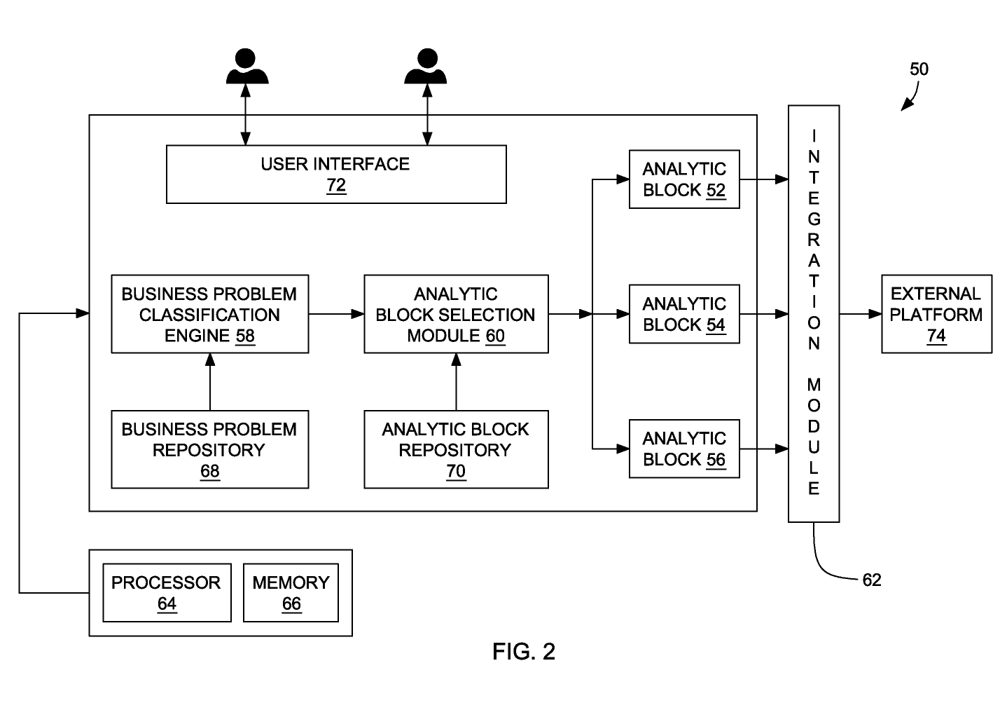

The connections, such as 26 and 28, connecting the business problems such as 12, 14 and 18 enable a user to visualize several business problems in an interconnected pattern. As used herein, the term “user” may refer to both natural people and other entities that operate as a “user”. Examples include corporations, organizations, enterprises, teams, or other group of people. The connections such as 26, 28 enable a user to group the business problems in a number of problem classes such as represented by reference numerals 38 and 40. In particular, the business problems are grouped into problem classes based on the nature of the problems and the interactions between them using the connections 26 through 36. The manner in which the grouping of business problems is performed will be described in detail below. Moreover, solutions to the business problems 12 through 24 associated with problem classes such as 38 and 40 may be determined using an analytic framework that is described with reference to FIG. 2.

FIG. 2 is a block diagram of an adaptive analytics framework 50, according to an example embodiment. An adaptive analytics framework 50 (which may hereinafter be referred to as simply the framework 50) includes one or more customizable analytic blocks such as represented by reference numerals 52 through 56, a business problem classification engine 58, an analytic block selection module 60, and an integration module 62. Each component is described in further details below.

While FIG. 2 illustrates and the following provides a detailed description of various components/modules of the system 50, example embodiments are not limited thereto. For example, the above-identified modules of the system 50 may be implemented via one or more processors (e.g., the processor 64), where the one or more processor is configured to execute computer readable instructions stored on a memory (e.g., the memory 66) to carry out the functionalities of each of the above-identified modules, which will be further described below.

In one example embodiment, the business problem classification engine 58 receives one or more business problems such as business problems 12 through 24 of FIG. 1. In one example embodiment, the problem may include a variety of business problems experienced by an establishment/entity. For example, a problem may be defined as lower than expected sale of a product in a retail store.

In some examples, the business problem classification engine 58 receives a problem statement corresponding to a business problem. Further, the business problem classification engine 58 is configured to identify at least one attribute contributing to the business problem based upon a situation-control-question (SCQ) matrix, a factor map and a hypothesis matrix associated with the business problem. The business problem classification engine 58 is configured to generate a comprehensive version of the business problem based on the identified at least one attribute.

In one embodiment, the SCQ matrix is represented using a current state of the problem, a desired solution of the problem and gaps between the current state and the desired solution of the problem. Further, the factor map includes the various factors that directly or indirectly contribute to the defined problem. The hypothesis matrix includes a set of hypothetical statements. Each hypothetical statement may include one or more component questions. In addition, a set of data elements associated with the hypothetical statement is also identified. The details of the generation of the comprehensive version of the business problem based on the identified attribute is described in India patent application number 2495/CHE/2014 titled “Business Problem Networking System and Tool” filed on the 19th of May 2014 and is incorporated herein

The business problem classification engine 58 is further configured to identify a problem class of the business problem using the comprehensive version of the business problem. In operation, the business problem classification engine 58 is configured to access a business problem repository 68 and to compare the business problem to other business problems stored in the repository 68 to determine the problem class of the respective business problem.

In one embodiment, the business problem classification engine 58 may include a connection engine (not shown) that is coupled to the business problem repository 68 and is configured to identify one or more connections between the business problems. In one embodiment, the connection engine is configured to assign a weight for each connection. In addition, the connection engine is configured to assign a direction for each of the connections. In one embodiment, the connections between the business problem statements are generated by comparing the components associated with each business problem.

The business problem classification engine 58 is configured to assign a rank to each business problem using the identified connections. The business problem classification engine 58 is further configured to group the business problem statements into one or more problem classes such as 38 and 40 of FIG. 1.

The analytic block selection module 60 is configured to identify one or more customizable analytic blocks such as 52 through 56 from an analytic block repository 70 based upon the determined problem class of the business problem. In some examples, a user of the system 50 may identify the one or more customizable analytic blocks such as 52 through 56 from the analytic block repository 70 based upon the determined problem class. Each of the customizable analytic blocks 52 through 56 is configured to receive input data associated with the business problem and to implement an analytic workflow to determine one or more solutions to the business problem.

In one example embodiment, input data associated with the problem may include details of the problem to be formulated and analyzed for achieving a desired solution (e.g., a desired level of sale of a product). The input data may also include possible factors and parameters affecting the problem (e.g., seasonal factors, holidays, quarterly sales, geographical location where the product is sold, etc.). In one or more example embodiments, such input data may be obtained from people and/or systems associated with the respective operating environment via a variety of data collection mechanisms such as surveys, assessments and so forth. The input data may be provided to the analytic blocks 52 through 56 using user interface 72.

The integration module 62 is configured to facilitate integration of the identified analytic blocks such as 52 and 54 with an external platform 74. The external platform 74 is a platform associated with business organizations, retail outlets, consumer outlets, and the like. In this example, the analytic blocks 52 through 56 includes a source code and a user of the external platform 74 may customize the source code based upon a type of the business problem. In one example, one or more code wrappers are associated with the one or more analytic blocks 52 through 56 of the framework 50. In some embodiments, the framework 50 is configured to be implemented in coordination with an automated workflow of the external platform 74. In some examples, the analytic block selection module 60 is configured to select a plurality of analytic blocks such as 52 through 56 based upon the type of the business problem and to couple the selected analytic blocks to determine the one or more solutions to the business problem.

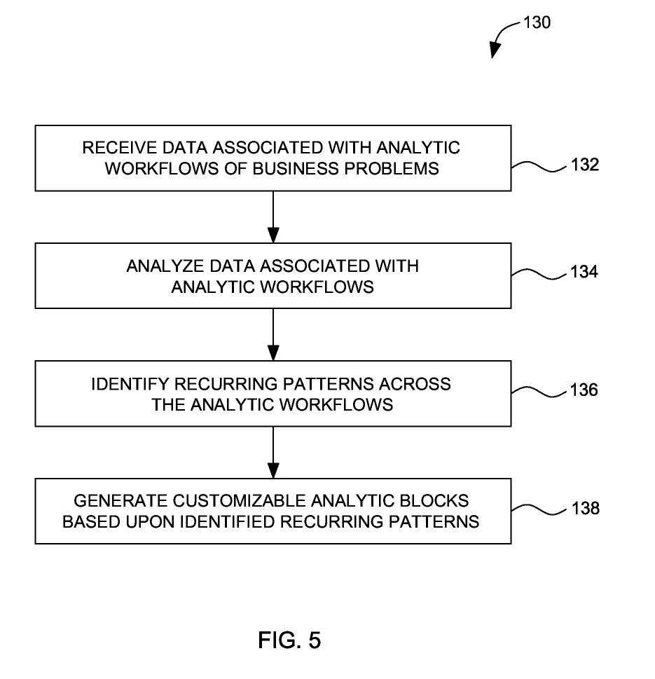

In some examples, each of the analytic blocks 52 through 56 is generated based upon data associated with solutions of a plurality of business problems in the respective problem class. The manner in which these analytic blocks 52 through 56 are generated will be described in detail with reference to FIG. 5.

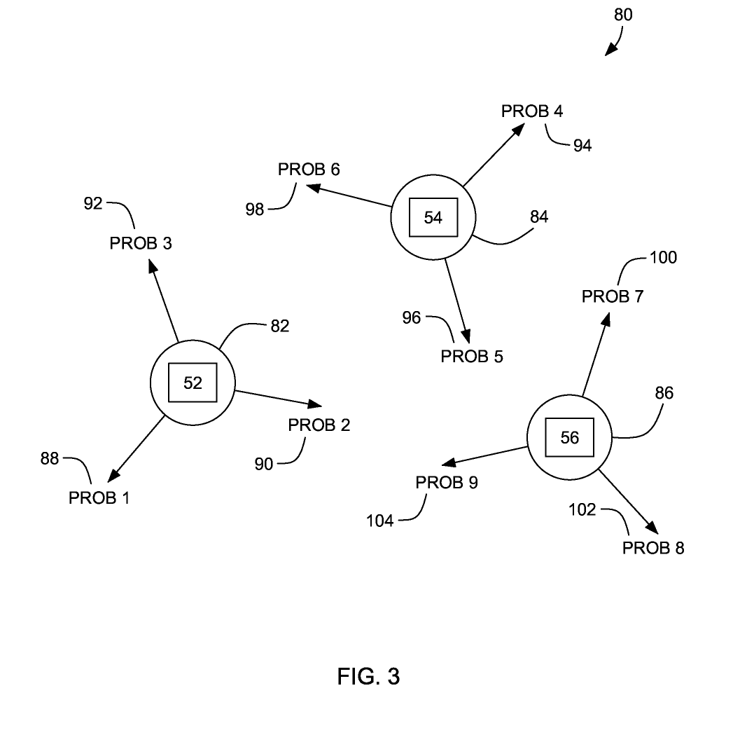

FIG. 3 is an example representation 80 of customizable analytic blocks for providing solutions to business problems associated with a plurality of problem classes, according to an embodiment. In this example, the customizable analytic blocks 52, 54 and 56 are associated with problem classes 82, 84 and 86 respectively. Each of the problem class such as 82 includes a variety of business problems such as generally represented by reference numerals 88 through 102.

For example, the problem class 82 may be a segmentation class that may include business problems such as customer segmentation 88, retail store segmentation 90 and offers segmentation 92 for a retail store. The analytic block 54 is configured to determine solutions for business problems 88, 90 and 92 of the problem class 82. Similarly, problem class 84 may be an optimization class that may address business problems such as pricing optimization 94, route optimization 96 and portfolio optimization 98. The analytic block 56 is configured to determine solutions for business problems 94, 96 and 98 of the problem class 82.

It should be noted that a variety of such problem classes having different business problems may be envisaged. Based upon the problem class to which a business problem corresponds to, the analytic block selection module 60 can identify one or more customizable analytic blocks such as 52 through 56 to determine the solutions to the respective business problem. In one example, the analytic block selection module 60 is configured to couple a plurality of such analytic blocks into an analytics package and the integration module 62 couples the analytics package to the external platform 74.

Each of the customizable analytic blocks 52 through 56 is configured to receive input data associated with the business problem such as 88 through 102 and to implement an analytic workflow to determine one or more solutions to the respective business problem.

In one example, the analytic block such as 52 analyzes the input data to generate one or more models and to provide one or more solutions to the business problem such as 88 through 92 using the one or more models. The analytic block 52 includes multiple modules that may implement statistical processes to generate output data. Such output data may be utilized by the user while implementing key business decisions. Thus, the current technique provides with analytic blocks as modularized frameworks that include source code open for viewing and modification. The customized analytic blocks provide the scalability and flexibility to address a wide variety of business problems and are customizable based upon the types of business problems. Such analytic framework enables better quality solutions to the business problems and can be re-used across business functions and use cases. Also, the use of customized analytic blocks enables faster time to market and allows for easy integration with existing technology and infrastructure of business establishments.

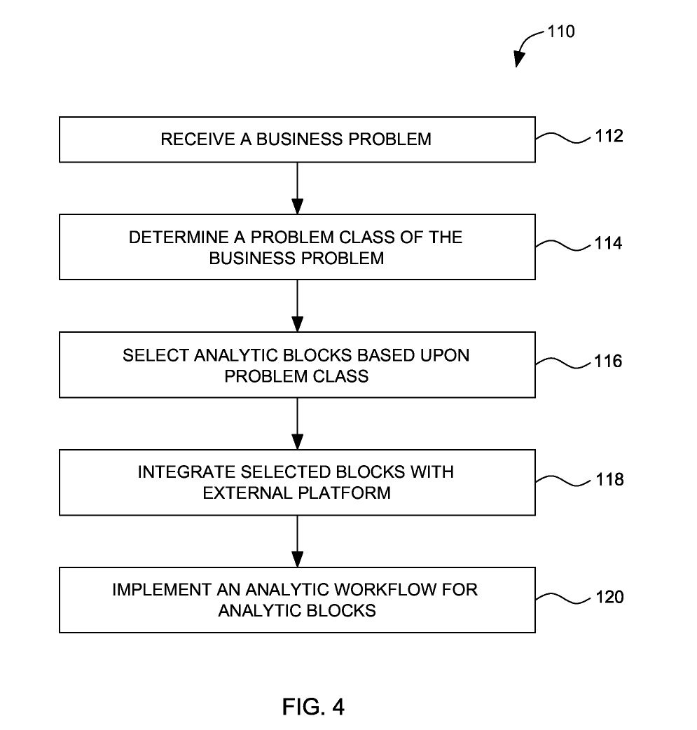

FIG. 4 is a flow chart illustrating a process 110 for solving a business problem using the analytics framework 50 of FIG. 2, according to an example embodiment. FIG. 4 will be described from the perspective of a processor (e.g, the processor 64) that is configured to execute computer-readable instructions to carry out the functionalities of the above-described modules of the system 50 shown in FIG. 2.

At step 112, a business problem is received by the analytics framework 50. In one example embodiment, the business problem may include a variety of business problems experienced by an establishment. The establishment may include business organizations, retail outlets, consumer outlets, hotels or combinations thereof. However, a variety of other problems in different environments may be defined in a similar way. Examples of business problems include, but are not limited to, determining key drivers from the sales of a product, cross-sell analysis, determining key factors that influence a customer purchasing behavior and the like.

At step 114, the business problem classification engine 58 determines a problem class of the business problem. At step 116, the analytic block selection module 60 selects one or more analytic blocks (e.g., 52 through 56) based upon the determined problem class.

At step 118, the integration module 62 integrates the selected analytic blocks with the external platform 74. In some embodiments, a plurality of analytic blocks are stitched together to form an analytic package and then the analytic package is coupled to the external platform 74. At step 120, each of the analytic blocks implements an analytic workflow to generate solutions of the business problems. The analytic workflow may be implemented via one or more processors 64, where the one or more processor 64 is configured to execute computer readable instructions stored on the memory 66 to carry out the analytic workflow and to generate the solutions of the business problem.

FIG. 5 is a flow chart illustrating a process 130 for generating the customizable analytic blocks of FIG. 2, according to an example embodiment. Each step is described in further detail below. FIG. 5 will be described from the perspective of a processor (processor 64) that is configured to execute computer-readable instructions to carry out the functionalities of the above-described modules of the system 50 shown in FIG. 2.

At step 132, the processor 64 receives data associated with analytic workflows of a plurality of business problems. The plurality of business problems are associated with one or more problem classes. The data may include input data such as data received from social media platforms, data pertaining to sales of a product, marketing data collected around a marketing campaign for a particular product, and the like. The data may also include the details of models utilized to provide one or more solutions to the business problems. Examples of models used for problem solving include linear regression, logistic regression, multi-logistic regression, general linear modeling, generalize liner modeling, or combinations thereof. Further, the data may also include one or more solutions to the business problem generated using the one or more generated models.

At step 134, the processor 64 analyzes the data associated with the analytic workflows of the business problems. At step 136, the processor 64 identifies recurring patterns across the analytic workflows of the business problems in the respective problem class. In this example, learnings from various problem solving experiences in a problem class are abstracted and generalized.

At step 138, the processor 64 generates one or more customizable analytic blocks based upon the identified recurring patterns. In particular, the learnings from previous solutions of the business problems in the respective problem classes are modularized to create the customizable analytic blocks. Each of the customizable analytic blocks are configured to implement an analytic workflow to generate solutions of the business problems in the respective problem class. In this example, each of the customizable analytic blocks includes a source code that is customizable based upon a type of the business problem. The analytic blocks may be deployed for a wide range of business problems. In some examples, the analytic blocks may be coupled with a third party software of an establishment.

In one example embodiment, the above mentioned analytic framework of FIG. 1 is used for solving a business problem in an establishment. The above described system and method for implementing an analytic framework for solving a business problem, may employ several user interfaces to enable the user to select one or more customizable analytic blocks based upon the problem class of the business problem and to implement analytic workflows for the selected analytic blocks to generate solutions of the business problems. Some example embodiments are described in further detail below with regard to example business problems. It is noted that the present technique is by no means intended to be limited to these example embodiments.

As an example of a business problem, identification of a category of accounts for a mass media organization is performed. The category includes the accounts that may be at risk. The mass media organization uses a model with a Gradient Boosted Decision Tree with Grid Search to identify if an account is at risk. In this example, the business problem classification engine 58 identifies a problem class of the business problem as a classification class that relates to problems related to classification of sectors, products and so forth. The analytic block selection module 60 selects a customizable analytic block that is configured to implement a classification analytic workflow and determine solutions to the current classification problem.

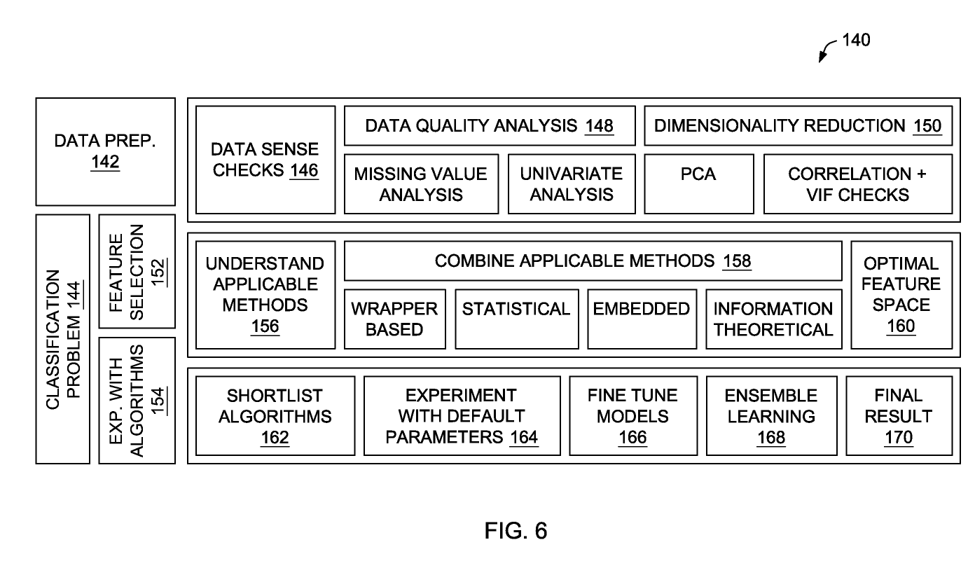

FIG. 6 shows an example layout 140 with phases of analytic workflow implemented to solve the business problem described above, according to an example embodiment. The analytic block is configured to implement the work flow corresponding to data preparation 142 and to determine the solutions for the current classification problem 144. The input data for the classification business problem is received and is prepared for implementation of the analytic workflow. The input data may be processed for data sense checks (as represented by reference numeral 146), data quality analysis (as represented by reference numeral 148) and dimensionality reduction (as represented by reference numeral 150). Each of these data preparation steps may include additional processing steps. For example, the data quality analysis 148 may include missing value analysis and univariate analysis for preparing the input data.

The analytic block is configured to implement the workflow to determine the solutions for the classification problem 144. The workflow may include feature selection (as represented by reference numeral 152) and experiments with algorithms (as represented by reference numeral 154). The feature selection process 152 may include understanding applicable methods for the specific business class 156, combining relevant applicable methods 158 and determining optimal feature space 160. Examples of applicable methods include, but are not limited to, wrapper based, statistical, embedded and information/theoretical methods. One or more of these methods may be combined and used.

Further, experiments with algorithms 154 may include shortlisting of algorithms 162, experiment using default parameters 164, fine tuning of the models 166, ensemble learning 168, and generating the final result 170. It should be noted that the analytical process flow for model building may be automated using the customized analytic block by coupling specific utilities with the analytic block addressing the classification business problem. Here, structured data is gathered from a variety of sources, which is processed and filtered to create an analytical dataset. Further the data is pre-processed using variety of techniques to prepare the analytical dataset. Feature selection is performed using embedded methods like Random forest (Boruta) to shortlist features and combined feature selection learning is obtained from multiple algorithms to generate solutions to the business problem.

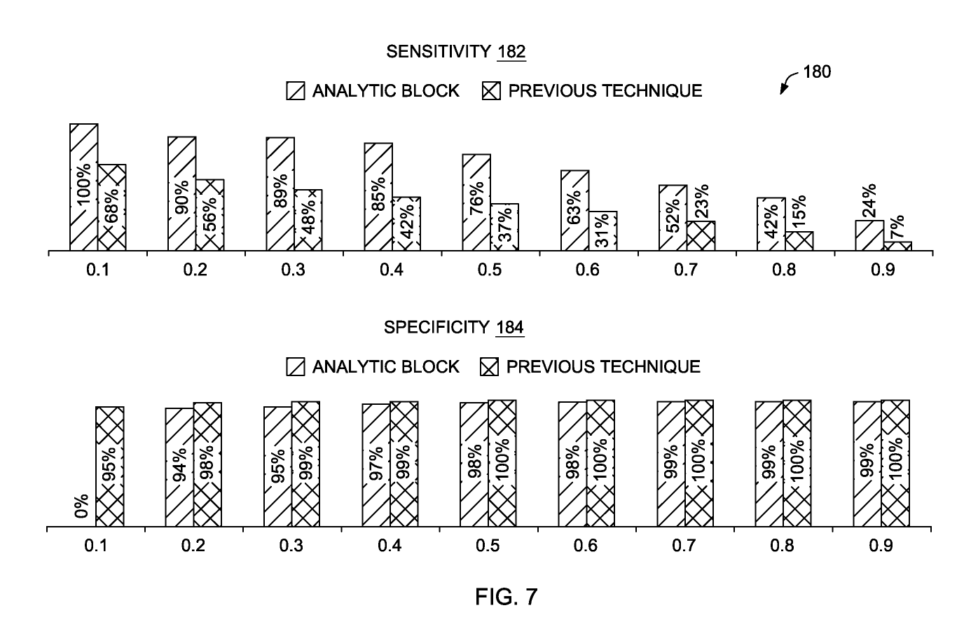

In this example, the accuracy of identifying the risk accounts for the organization using the current technique was substantially higher than the previously used technique with model having Gradient Boosted Decision Tree with Grid Search. FIG. 7 is a graphical representation 180 of the sensitivity and specificity of the results obtained using the customized analytic block and previous techniques. The sensitivity of the results is represented by bar chart 182 and the specificity of the results is represented by bar chart 184. In this embodiment, the sensitivity represents the accuracy for “At Risk” accounts and the specificity represents the accuracy for “Not at Risk” accounts. Here about 39% increase in accuracy was determined for identification of risk accounts using the current technique.

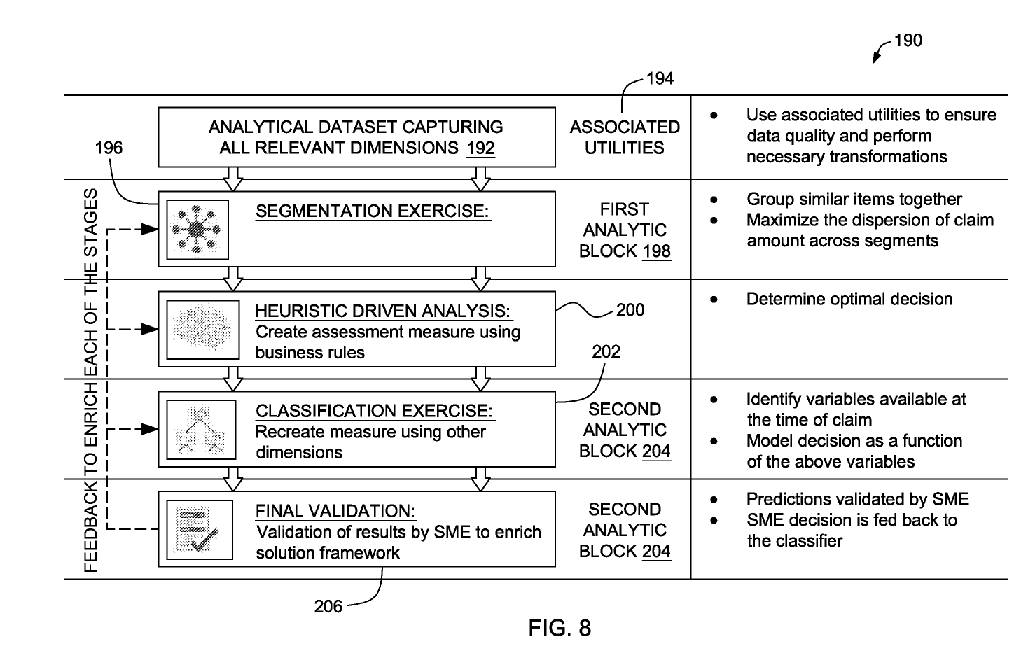

As another example of a business problem, segregating of claims into cash settlement and repair is performed using the current technique. FIG. 8 shows an example layout 190 with phases of analytic workflow implemented to solve the business problem described above, according to an example embodiment. Here, analytical dataset 192 capturing the dimensions for the business problem is received. Further, associated utilities such as represented by reference numeral 194 are used to process the data to ensure data quality. As represented by reference numeral 196, segmentation of the dataset 192 is performed to create claim segments to enrich business interpretation. Here the segmentation is performed using a first analytic block 198 that implements an analytic workflow for solving problems in segmentation problem class. The first analytic block 198 is configured to group substantially similar items together and to maximize the dispersion of claim amount across various segments.

Next, a heuristic driven analysis is performed (as represented by reference numeral 200) to determine optimal decision based on pre-determined criteria for claim life and amount. Further, classification of the data is performed (as represented by reference numeral 202) using a second analytic block 204 that implements an analytic workflow for solving problems in classification problem class. The second analytic block 204 is configured to identify variables available at the time of claim and arrive at a model decision as a function of the identified variables. Next, final validation is performed (as represented by reference numeral 206) via the second analytic block 204. The second analytic block 204 is configured to perform validation of results to generate the solutions of the business problem.

As described above, two customized analytic blocks were used to generate solutions for the classification and segmentation business problems thereby enhancing solution optimality and confidence. In this example, the results obtained using the second analytic block had about 95% accuracy where the block utilized 7 algorithms for the classification problem. Further, 10 algorithms including Random Forest, Extra Trees, MLP Classifier, LDA, SVC, Ensemble, Ensemble with grid search, Ada Boost, Stacking, Logistic Regression were implemented by the second analytic block 204. Moreover, the first analytic block 198 used 8 segments for the segmentation problem where K-modes were used for the segmentation. Further, 9 algorithms including K-Means, Agglomerative, Mean-Shift, AffinityPropagation, DBSCAN, Fuzzy C-means, BIRCH, K-Medoids, K-Modes were implemented by the first analytic block 198.

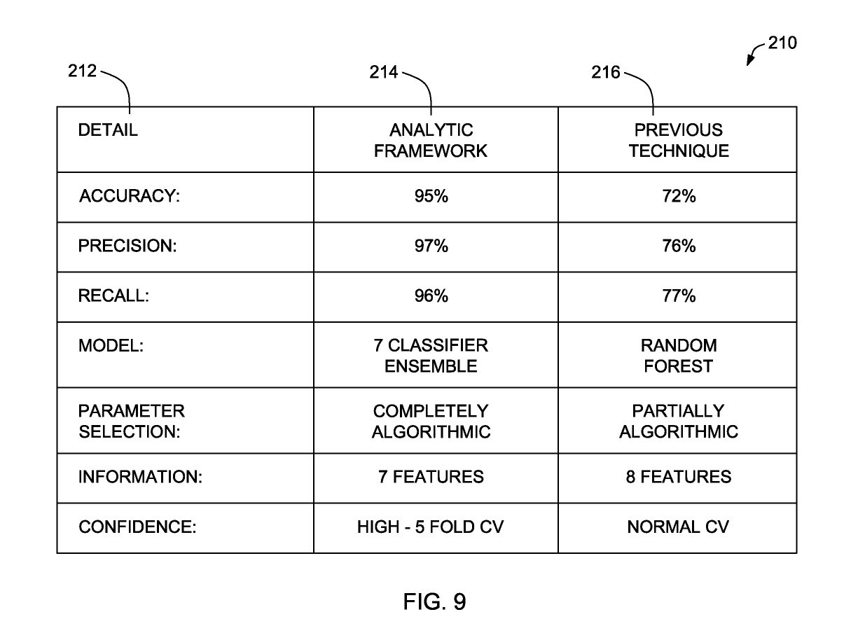

FIG. 9 is a table 210 with comparison of results obtained for the above-described classification business problem using the analytic software and the previous technique. The details of the measured parameters are represented by column 212, the results with the analytic framework of FIG. 2 and the previously used technique are represented by columns 214 and 216 respectively. As can be seen, the accuracy of the results using the analytic framework was about 95% that was substantially higher than results obtained using the previous technique, that was around 72%. Similarly, the precision of the results using the analytic framework was about 97% that was substantially higher than results obtained using the previous technique (76%). The model used for the analytic framework was a 7 classifier ensemble, whereas for the previous technique it was Random Forest. Moreover, the parameter selection for the analytic framework was completely algorithmic, whereas for the previous technique it was partially algorithmic. As can be seen from table 210, the analytic framework provided substantially better results than using the currently available techniques. Furthermore, the analytic framework can be customized based upon the specific requirements to provide solutions for a wide variety of business problems.

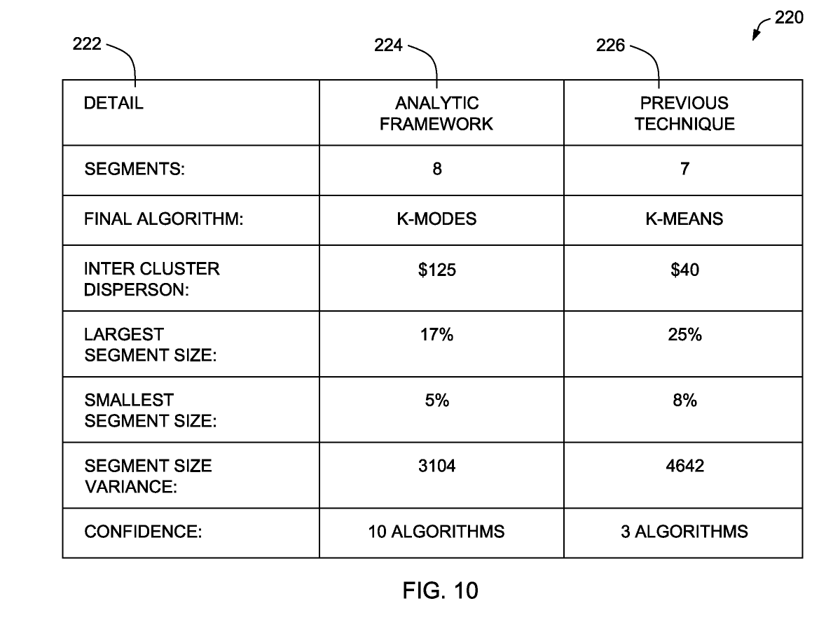

FIG. 10 is a table 220 with comparison of results obtained for the above-described segmentation business problem using the analytic software and the previous technique. The details of the measured parameters are represented by column 222, the results with the analytic framework of FIG. 2 and the previously used technique are represented by columns 224 and 226 respectively. As can be seen, with the analytic framework, the number of segments was about 8 as compared to 7 with the previous technique. Other parameters such as inter cluster dispersion, largest and smallest segment size and the segment size variance also showed relatively better results with the analytic framework as compared to the previous technique. The implementation of the analytic workflow using the second analytic block for solving the segmentation business problem helped improve the experiment with 10 algorithms (as compared to 3 algorithms in the current technique) within the same time that led to identification of one nee segment.

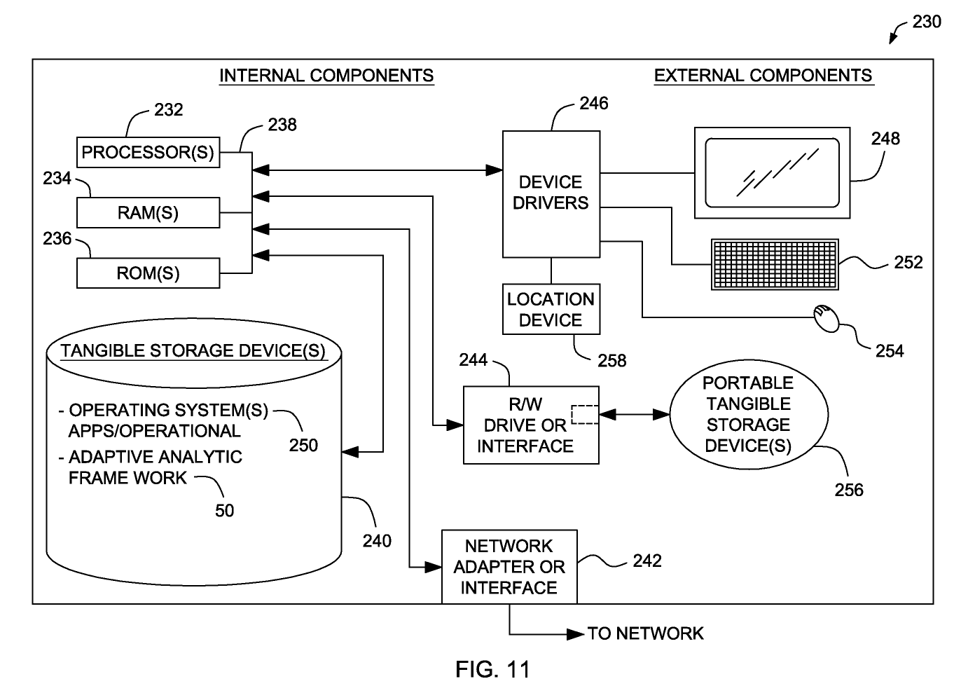

The modules of the adaptive analytic framework 50 described herein are implemented in computing devices. One example of a computing device 230 is described below in FIG. 11. The computing device includes one or more processor 232, one or more computer-readable RAMs 234 and one or more computer-readable ROMs 236 on one or more buses 238. Further, computing device 230 includes a tangible storage device 240 that may be used to execute operating systems 242 and adaptive analytic framework 100. The various modules of the adaptive analytic framework 50 including a business problem classification engine 58, an analytic block selection module 60, and analytic blocks such as 52 through 56 may be stored in tangible storage device 238. Both, the operating system 248 and the adaptive analytic framework 100 are executed by processor 232 via one or more respective RAMs 234 (which typically include cache memory). The execution of the operating system 248 and/or the analytics system 100 by the processor 232 configures the processor 232 as a special purpose processor configured to carry out the functionalities of the functionalities of the operation system 248 and/or the analytics system 100, as described above.

Examples of storage devices 238 include semiconductor storage devices such as ROM 236, EPROM, flash memory or any other computer-readable tangible storage device that may store a computer program and digital information.

Computing device also includes a R/W drive or interface 242 to read from and write to one or more portable computer-readable tangible storage devices 254 such as a CD-ROM, DVD, memory stick or semiconductor storage device. Further, network adapters or interfaces 240 such as a TCP/IP adapter cards, wireless Wi-Fi interface cards, or 3G or 4G wireless interface cards or other wired or wireless communication links are also included in computing device.

In one example embodiment, the adaptive analytic framework 50 which includes a business problem classification engine 58, an analytic block selection module 60, and analytic blocks such as 52 through 56 may be stored in tangible storage device 238 and may be downloaded from an external computer via a network (for example, the Internet, a local area network or other, wide area network) and network adapter or interface 240.

Computing device further includes device drivers 244 to interface with input and output devices. The input and output devices may include a computer display monitor 246, a keyboard 250, a keypad, a touch screen, a computer mouse 252, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure and appended claims.

References back that are used in dependent claims indicate the further embodiment of the subject matter of the main claim by way of the features of the respective dependent claim, they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions, which have a configuration that is independent of the subject matters of the preceding dependent claims.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of inventive concepts, and all such modifications as would be obvious to one skilled in the art are intended to be included within the scope of the following claims.

What is claimed is:

1. An adaptive analytics framework, the adaptive analytics framework comprising:
one or more customizable analytic blocks, wherein each of the analytic blocks is configured to receive input data associated with at least one business problem and to implement an analytic workflow to determine one or more solutions to the business problem; and
an integration module configured to facilitate integration of the one or more customizable analytic blocks with an external platform.

2. The adaptive analytics framework of claim 1, wherein each of the one or more customizable analytic blocks comprises a source code and wherein a user of the external platform is configured to customize the source code based upon a type of the business problem.

3. The adaptive analytics framework of claim 1, wherein each of the analytic blocks is configured to determine solutions to one or more business problems associated with a pre-determined problem class.

4. The adaptive analytics framework of claim 1, wherein the analytic workflow associated with each of the customizable analytic blocks is generated based upon data associated with solutions of a plurality of business problems in the respective problem class.

5. The adaptive analytics framework of claim 1, wherein the external platform comprises a platform associated with business organizations, retail outlets, consumer outlets, hotels, or combinations thereof.

6. The adaptive analytics framework of claim 1, further comprising an analytic block selection module configured to select a plurality of analytic blocks based upon the type of the business problem and to couple the selected analytic blocks to determine the one or more solutions to the business problem.

7. The adaptive analytics framework of claim 1, further comprising one or more code wrappers associated with the one or more the customizable analytic blocks of the framework.

8. The adaptive analytics framework of claim 1, wherein the framework is configured to be implemented in coordination with an automated workflow of the external platform.

9. An adaptive analytics framework, the adaptive analytics framework comprising:
a memory having computer-readable instructions stored therein; and
a processor configured to:
receive one or more business problems;
identify one or more customizable analytic blocks based upon a problem class of the one or more business problems, wherein each of the customizable analytic blocks is configured to receive input data associated with the one or more business problems and to implement an analytic workflow to determine one or more solutions to the business problem; and
an integration module configured to facilitate integration of the identified one or more customizable analytic blocks with an external platform.

10. The adaptive analytics framework of claim 9, wherein the processor is further configured to execute the computer-readable instructions to:
analyze data associated with solutions of a plurality of business problems of one or more problem classes:
identify recurring patterns across the solutions of the business problems in the respective problem class; and
generate the one or more customizable analytic blocks based upon the identified recurring patterns.

11. The adaptive analytics framework of claim 9, wherein the processor is further configured to execute the computer-readable instructions to couple a plurality of customizable analytic blocks into an analytics package and wherein the integration module is configured to couple the analytics package to the external platform.

12. The adaptive analytics framework of claim 9, wherein each of the one or more customizable analytic blocks comprises a source code and wherein a user of the external platform is configured to customize the source code based upon a type of the business problem.

13. An adaptive analytics framework, the adaptive analytics framework comprising:
a memory having computer-readable instructions stored therein; and
a processor configured to:
analyze data associated with analytic workflows of a plurality of business problems of one or more problem classes;
identify recurring patterns across the analytic workflows of the business problems in the respective problem class; and
generate one or more customizable analytic blocks based upon the identified recurring patterns, wherein the one or more customizable analytic blocks are configured and implement an analytic workflow to generate solutions of the business problems in the respective problem class.

14. The adaptive analytics framework of claim 13, wherein the processor is further configured to execute the computer-readable instructions to:
receive input data associated with one or more business problems in a problem class;
identify one or more customizable analytic blocks for the problem class;
implement the analytic workflow to determine one or more solutions to the business problem.

15. The adaptive analytics framework of claim 14, further comprising an integration module configured to facilitate integration of the identified one or more customizable analytic blocks with an external platform.

16. The adaptive analytics framework of claim 15, wherein each of the one or more customizable analytic blocks comprises a source code and wherein a user of the external platform is configured to customize the source code based upon a type of the business problem.

17. An adaptive analytics framework, the adaptive analytics framework comprising:
a memory having computer-readable instructions stored therein; and
a processor configured to:
receive a problem statement corresponding to a business problem;
identify at least one attribute contributing to the business problem based upon a situation-control-question (SCQ) matrix, a factor map and a hypothesis matrix associated with the business problem;
generate a comprehensive version of the business problem based on the identified at least one attribute;
identify one or more customizable analytic blocks based upon a problem class of the comprehensive version of the business problem, wherein each of the customizable analytic blocks is configured to receive input data associated with the business problem and to implement an analytic workflow to determine one or more solutions to the business problem; and
an integration module configured to facilitate integration of the identified one or more customizable analytic blocks with an external platform

18. The adaptive analytics framework of claim 17, wherein the processor is further configured to:
create the SCQ matrix for the problem statement to enable one or more users to define a current state and a desired state;
create the factor map to enable the one or more users to enumerate a plurality of factors contributing to the problem; and
create the hypothesis matrix with one or more hypothetical statements corresponding to the problem statement to be completed by the one or more users.

19. The adaptive analytics framework of claim 18, wherein the processor is further configured to create the SCQ matrix in order to enable the one or more users to identify gaps between the current state and the desired state.

20. The adaptive analytics framework of claim 17, wherein each of the one or more customizable analytic blocks comprises a source code and wherein a user of the external platform is configured to customize the source code based upon a type of the business problem.

21. An adaptive analytics framework, the adaptive analytics framework comprising:
a memory having computer-readable instructions stored therein; and
a processor configured to:
receive a problem statement corresponding to a business problem;
determine one or more connections for the problem statement by comparing the problem statements with a plurality of plurality of business problem statements and to generate a connection score for the problem statement;
determine a problem class of the business problem based on the generated connection score;
identify one or more customizable analytic blocks based upon the problem class of the one or more business problems, wherein each of the customizable analytic blocks is configured to receive input data associated with the one or more business problems and to implement an analytic workflow to determine one or more solutions to the business problem; and
an integration module configured to facilitate integration of the identified one or more customizable analytic blocks with an external platform.

22. A method of solving a business problem, the method comprising:
determining a problem class of one or more business problems;
selecting one or more customizable analytic blocks based upon the problem class;
integrating the selected customizable analytic blocks with an external platform;
implementing an analytic workflow for the selected customizable analytic blocks to generate solutions of the one or more business problems.

23. The method of claim 22, further comprising customizing the one or more analytic blocks based upon a type of the business problems.
